(19) United States
(12) Patent Application Publication
(10) Pub. No.: US 2010/0172003 A1
(43) Pub. Date: Jul. 8, 2010

(54) HOLOGRAM APPARATUS AND RECORDING AND REPRODUCING METHOD OF THE SAME

(75) Inventor: Akihiro Tachibana, Tokyo (JP)

Correspondence Address: DRINKER BIDDLE & REATH (DC), 1500 K STREET, N.W., SUITE 1100, WASHINGTON, DC, 20005-1209, US

(73) Assignee: Pioneer Corporation, Tokyo (JP)

(21) Appl. No.: 12/663,787

(22) PCT Filed: Jun. 11, 2007
(86) PCT No.: PCT/JP2007/061724

§ 371 Date: Jan. 11, 2010

(51) Int. Cl. G03H 1/26

(52) U.S. Cl. 359/22

(57) ABSTRACT

A hologram apparatus which comprises a light generating unit that generates coherent reference light and coherent signal light modulated according to information to be recorded; an interference optical system that irradiates the signal light and the reference light toward the record medium to intersect therein, thus forming a diffraction grating inside the record medium by an optical interference pattern; and a photodetector that detects reproduced light. The hologram apparatus further comprises a second interference optical system that irradiates second signal light and second reference light to intersect inside the record medium, wherein the second signal light and the second reference light are placed in the plane of incidence including the signal light and the reference light of the interference optical system so as to be opposite to the signal light and the reference light with the record medium sandwiched in between; and a second photodetector that detects reproduced light.

### TECHNICAL FIELD

The present invention relates to a hologram apparatus for a hologram record carrier that information can be recorded into or reproduced from by irradiating a beam, such as an optical disc or an optical card and particularly to a hologram apparatus used in an angle multiplexing scheme, a shift multiplexing scheme, etc., and the recording and reproducing by the same.

### BACKGROUND ART

Holograms, which can record two-dimensional data such as images at high densities, are attracting attention for high density information recording. The characteristic of holograms is that an optical interference pattern between the wavefront of signal light carrying information to be recorded and the wavefront of reference light is recorded as a diffraction grating in a hologram record carrier. That is, the optical paths of the reference light and of the signal light are spatially separated from each other, and the two are made to intersect and interfere in the hologram record carrier so as to record information.

By multiplex-recording optical interference patterns in a hologram record carrier, recording capacity can be dramatically increased. For example, with the angle multiplexing scheme, when recording, the angle of reference light relative to signal light, so-called intersecting angle, in a hologram record carrier is changed little by little, each time maintaining the angle for a certain period of time, thereby multiplex-recording different information for each angle in the same area.

For example, a hologram apparatus which, in hologram recording and reproducing, improves recording density and recording capacity and performs a recording/reproducing operation accurately and quickly (See Patent Document 1). In this hologram apparatus, parameter setting means that can change and fix parameters for multiplex-recording such as the recording angle and the depth of focus is provided for at least one of the signal light and the reference light, and the apparatus comprises moving means for moving the converging position of the signal light and the reference light relative to a hologram record medium in a direction along the recording surface thereof and control means for this. Under the control of the control means, recording is performed using the parameters for multiplex-recording lastly used when recording at a certain converging position as first parameters for multiplex-recording when recording at the next converging position.

FIG. 1 shows this hologram recording apparatus 100. The hologram recording apparatus comprises a recording angle changing unit 19 that can change little by little and fix the angles of signal light L3 and reference light L2 relative to the surface of a hologram record medium 200 and a control unit 18 that controls the recording angle changing unit 19 to make the signal light L3 be at the recording angle corresponding to an angle record face to be recorded into, in the hologram record medium 200. The hologram recording apparatus is configured such that the angles relative to the optical axis and the arrangement of a laser unit 11, a beam splitter 12, lenses 13, 14, 16, and a spatial light modulator 15 are changeable. The hologram recording apparatus further comprises a lens 24a to condense reproduced light L12 from the hologram record medium 200 due to reproducing irradiation light; a light receiving unit 25a on the other side to receive the reproduced light L12 via the lens 24a; and a reading-out unit 26a to read each of a plurality of recorded information multiplex-recorded in the hologram record medium 200 based on the received reproduced light L12, i.e., a received light signal Sr output from the light receiving unit 25a.

Patent Document 1: Japanese Patent Application Laid-Open Publication No. 2003-337525.

Patent Document 2: Japanese Patent Application Laid-Open Publication No. 2004-272268.

### DISCLOSURE OF THE INVENTION

### Problems to be Solved by the Invention

As such, conventionally, in the case of recording and reproducing transmission holograms in the angle multiplexing manner, an irradiating optical system and a light receiving optical system need to be provided on opposite sides of the hologram record medium 200. In order to double the transfer rate, two heads each having optical systems on opposite sides of the record medium need to be used to perform simultaneous recording/reproducing.

In the conventional art, there are optical systems on opposite sides of the record medium, but recording/reproducing is performed on one area at a time. Thus, in order to double the transfer rate, two heads need to be used to perform simultaneous recording/simultaneous reproducing on two areas. Further, the configuration of the optical systems needs to be changed between in normal reproduction and in phase conjugate reproduction.

The invention was made in view of the above-mentioned problems, and a task thereof is to provide a hologram recording apparatus that increases the transfer rate and enables high speed operation.

A second task thereof is to solve the problem that although the dynamic range of record media has been improved and thus the multiplexing number can be increased, the dynamic range of record media is not being made full use of because the angle-multiplexing number is limited due to angle selectiveness. The conventional art of Patent Document 2 tried to solve this problem by making hologram recording areas overlap partially.

### Means for Solving the Problems

A hologram apparatus of the present invention is a hologram apparatus which comprises a support removably holding a record medium that stores therein optical interference patterns between coherent signal light and reference light as diffraction gratings; a light generating unit that generates coherent reference light and coherent signal light modulated according to information to be recorded; an interference optical system that irradiates the signal light and the reference light toward the record medium to intersect therein, thus forming a diffraction grating inside the record medium by an optical interference pattern; and a photodetector that detects reproduced light. The hologram apparatus further comprises a second interference optical system that irradiates second signal light and second reference light to intersect inside the record medium, wherein the second signal light and the second reference light are placed in the plane of incidence including the signal light and the reference light of the interference optical system so as to be opposite to the signal light and the reference light with the record medium sandwiched in between; and a second photodetector that detects reproduced light.

A recording method of the present invention is a recording method in a hologram apparatus which comprises a support removably holding a record medium that stores therein optical interference patterns between coherent signal light and reference light as diffraction gratings; a light generating unit that generates coherent reference light and coherent signal light modulated according to information to be recorded; an interference optical system that irradiates the signal light and the reference light toward the record medium to intersect therein, thus forming a diffraction grating inside the record medium by an optical interference pattern; and a photodetector that detects reproduced light. The recording method comprises the steps of preparing a second interference optical system that irradiates second signal light and second reference light to intersect inside the record medium, wherein the second signal light and the second reference light are placed in the plane of incidence on the record medium including the signal light and the reference light of the interference optical system so as to be opposite to the signal light and the reference light with the record medium sandwiched in between, and a second photodetector that detects reproduced light; and irradiating by the interference optical system and the second interference optical system simultaneously the signal light and the reference light, and the second signal light and the second reference light onto the record medium.

A reproducing method of the present invention is a reproducing method in a hologram apparatus which comprises a support removably holding a record medium that stores therein optical interference patterns between coherent signal light and reference light as diffraction gratings; a light generating unit that generates coherent reference light; an optical system that irradiates the reference light toward the record medium; and a photodetector that detects reproduced light. The reproducing method comprises the steps of preparing a second optical system that irradiates second reference light, which is placed opposite to the reference light with the record medium sandwiched in between, toward the record medium and a second photodetector that detects second reproduced light; and irradiating by the optical system and the second optical system simultaneously the reference light and the second reference light onto the record medium. The reproduced light and the second reproduced light from the record medium are detected by the photodetector and the second photodetector, and the reproduced light and the second reproduced light travel in opposite directions from the record medium.

According to the present invention, the same optical systems are placed, e.g., twofold rotationally symmetrical on opposite sides of a record medium, and simultaneous recording/simultaneous reproducing can be performed by both the upper and lower optical systems. Further, as to reproduction, both of normal reproduction and phase conjugate reproduction can be dealt with.

According to the present invention, by having the optical systems placed on opposite sides of a record medium simultaneously operate, simultaneous recording/simultaneous reproducing can be performed on two adjacent areas, thus doubling the transfer rate. That is, what conventionally requires two heads can be realized by one head. Further, both normal reproduction and phase conjugate reproduction can be dealt with simply by switching software. Although the record medium is dividing into groups of two adjacent areas for convenience, they need not be physically divided areas. For example, it can be considered that areas recorded by the upper optical system when recording are upper areas and that areas recorded by the lower optical system are lower areas.

The same optical systems are placed rotationally symmetrical on opposite sides of a record medium, and by performing simultaneous recording/simultaneous reproducing by both the upper and lower optical systems, although with one head, doubling the transfer rate can be achieved as with two heads. Further, as to reproduction, both of normal reproduction and phase conjugate reproduction can be dealt with.

Yet further, the focal positions of the object lenses of the upper and lower optical systems are spaced apart in a direction of the optical axes, and in addition an area which is recorded by the upper optical system and an area which is recorded by the lower optical system are made to overlap completely, and thereby the recording capacity can be doubled.

### BRIEF DESCRIPTION OF DRAWINGS

FIG. 1 is a schematic configuration diagram showing a conventional hologram recording apparatus;

FIG. 2 is a schematic configuration diagram showing a hologram apparatus of an embodiment according to the present invention;

FIG. 3 is a schematic partially cross-sectional view showing in detail the part related to incidence on a record medium in the hologram apparatus of the embodiment according to the present invention;

FIG. 4 is a schematic partially cross-sectional view showing in detail the part related to incidence on the record medium in the hologram apparatus of the embodiment according to the present invention;

FIG. 5 is a schematic partially cross-sectional view showing in detail the part related to incidence on the record medium in the hologram apparatus of the embodiment according to the present invention;

FIG. 6 is a schematic configuration diagram showing a hologram apparatus of another embodiment according to the present invention;

FIG. 7 is a schematic partially cross-sectional view showing in detail the part related to incidence on a record medium in the hologram apparatus of the other embodiment according to the present invention;

FIG. 8 is a schematic partially cross-sectional view showing in detail the part related to incidence on the record medium in the hologram apparatus of the other embodiment according to the present invention;

FIG. 9 is a schematic partially cross-sectional view showing in detail the part related to incidence on the record medium in the hologram apparatus of the other embodiment according to the present invention;

FIG. 10 is a schematic partially cross-sectional view showing in detail the part related to incidence on the record medium in the hologram apparatus of the other embodiment according to the present invention;

FIG. 11 is a schematic configuration diagram showing in detail the part related to incidence on a record medium in a hologram apparatus of another embodiment according to the present invention;

FIG. 12 is a schematic configuration diagram showing in detail the part related to incidence on a record medium in a hologram apparatus of another embodiment according to the present invention; and

FIG. 13 is a schematic configuration diagram showing a hologram apparatus of another embodiment according to the present invention.

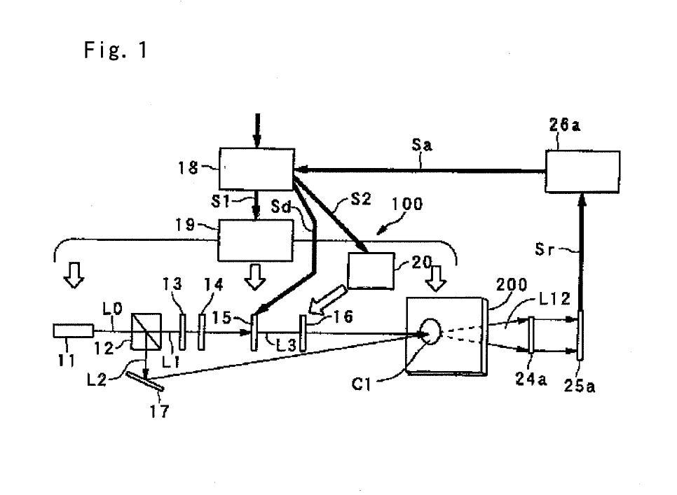

### EXPLANATION OF REFERENCE NUMERALS

a Upper light source
b Upper expander
c Upper first half-wave plate
d Upper first polarizing beam splitter
e Upper second expander
f Upper second polarizing beam splitter
g Upper spatial light modulator
h Upper photodetector
i Upper Fourier lens
j Upper second half-wave plate
k Upper mirror
l Upper mirror
m Upper galvanomirror
n Upper 4f lens
p Upper spatial filter
q Upper diaphragm
a1 Lower light source
b1 Lower expander
c1 Lower first half-wave plate
d1 Lower first polarizing beam splitter
e1 Lower second expander
f1 Lower second polarizing beam splitter
g1 Lower spatial light modulator
h1 Lower photodetector
i1 Lower Fourier lens
j1 Lower second half-wave plate
k1 Lower mirror
l1 Lower mirror
m1 Lower galvanomirror
n1 Lower 4f lens
p1 Lower spatial filter
q1 Lower diaphragm
o Record medium
SPP Support
CONL Control circuit

### DETAILED DESCRIPTION OF THE INVENTION

Embodiments of the present invention will be described below with reference to the drawings.

<Hologram Apparatus>

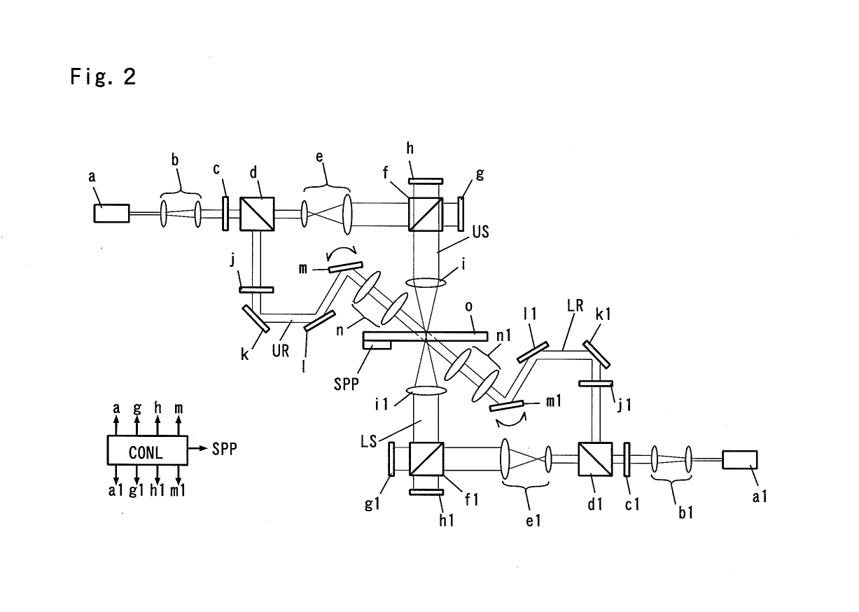

FIG. 2 shows a hologram apparatus of an embodiment, especially the optical system arrangement thereof. The hologram apparatus comprises a support SPP removably holding a record medium “o” that stores therein optical interference patterns between signal lights US, LS and reference lights UR, LR as diffraction gratings, and the same hologram recording/reproducing optical systems are placed rotationally symmetrical on the upper side and the lower side of the record medium “o”.

The upper hologram recording/reproducing optical system comprises, as shown in FIG. 2, an upper light source “a”, an upper expander “b”, an upper first half-wave plate “c”, an upper first polarizing beam splitter “d”, an upper second expander “e”, an upper second polarizing beam splitter “f”, an upper spatial light modulator “g”, an upper photodetector “h”, an upper Fourier lens “i”, an upper second half-wave plate “j”, an upper mirror “k”, an upper mirror “l”, an upper galvanomirror “m”, and an upper 4f lens “n”.

A light generation unit for the upper coherent signal light US and reference light UR comprises, for example, the upper light source “a”, the upper expander “b”, the upper first half-wave plate “c”, and the upper first polarizing beam splitter “d”. An interference optical system that directs the signal light US and reference light UR toward the record medium “o” and makes them intersect therein includes, for example, a signal light optical system comprising the upper second expander “e”, the upper second polarizing beam splitter “f”, the upper spatial light modulator “g”, the upper photodetector “h”, and the upper Fourier lens “i”, and a reference light optical system comprising the upper second half-wave plate “j”, the upper mirror “k”, the upper mirror “l”, the upper galvanomirror “m”, and the upper 4f lens “n”.

The lower hologram recording/reproducing optical system comprises, as shown in FIG. 2, as in the upper system, a lower light source “a1”, a lower expander “b1”, a lower first half-wave plate “c1”, a lower first polarizing beam splitter “d1”, a lower second expander “e1”, a lower second polarizing beam splitter “f1”, a lower spatial light modulator “g1”, a lower photodetector “h1”, a lower Fourier lens “i1”, a lower second half-wave plate “j1”, a lower mirror “k1”, a lower mirror “l1”, a lower galvanomirror “m1”, and a lower 4f lens “n1”.

A light generation unit for the lower coherent signal light LS and reference light LR comprises, for example, the lower light source “a1”, the lower expander “b1”, the lower first half-wave plate “c1”, and the lower first polarizing beam splitter “d1”. An interference optical system that directs the signal light LS and reference light LR toward the record medium “o” and makes them intersect therein includes, for example, a signal light optical system comprising the lower second expander “e1”, the lower second polarizing beam splitter “f1”, the lower spatial light modulator “g1”, the lower photodetector “h1”, and the lower Fourier lens “i1”, and a reference light optical system comprising the lower second half-wave plate “j1”, the lower mirror “k1”, the lower mirror “l1”, the lower galvanomirror “m1”, and the lower 4f lens “n1”. The upper and lower Fourier lenses, i.e. object lenses, have a common optical axis.

The hologram apparatus having the upper and lower interference optical systems irradiates the signal lights US, LS and reference lights UR, LR toward the record medium “o” of a parallel plate made of transparent recording material so as to intersect therein, thus forming diffraction gratings inside the record medium “o” by optical interference patterns.

In the upper and lower interference optical systems, in the plane of incidence (page plane) including the signal lights US, LS and reference lights UR, LR at the record medium “o”, the upper and lower signal lights US, LS and reference lights UR, LR are placed rotationally symmetrical (with respect to the intersection point of signal light and reference light) with the record medium in between, and pairs of the upper lights and the lower lights are each irradiated to intersect inside the record medium, and the upper and lower photodetectors “h, h1” to detect reproduced lights for the upper and lower optical systems are provided.

In the above, the case where the upper and lower optical systems are placed rotationally symmetrical has been described, but they need not necessarily be completely symmetrical, and the present invention can be implemented in cases where the upper optical system and the lower optical system are displaced parallel to the optical axis or are substantially symmetrical.

<Recording Operation of the Hologram Apparatus>

The operation when recording by the upper hologram recording/reproducing optical system is as follows.

Light emitted from the upper light source “a”, passes through the upper expander “b” and the upper first half-wave plate “c” to be divided into signal light that passes through the upper first polarizing beam splitter “d” and reference light that is reflected by it. Here, the ratio of the signal light to the reference light can be freely adjusted by the upper first half-wave plate “c”.

The signal light is expanded in beam diameter by the upper second expander “e”, passes through the upper second polarizing beam splitter “f”, and is incident on the upper spatial light modulator “g”. The components modulated to be in an ON state by this upper spatial light modulator “g” of a reflective type are inverted in polarization and reflected by the upper second polarizing beam splitter “f” to be incident on the upper Fourier lens “i”. The components of the light put in an OFF state at the spatial light modulator remain unchanged in polarization and hence passes through the upper second polarizing beam splitter “f” to go back toward the light source. The signal light condensed by the upper Fourier lens “i” is incident on the record medium “o”.

Meanwhile, the reference light reflected by the upper first polarizing beam splitter “d” passes through the upper second half-wave plate “j”, remaining unchanged in polarization and is reflected by the upper mirrors “k, l” to be directed toward the upper galvanomirror “m”. The reference light reflected by the upper galvanomirror “m” and having passed through the upper 4f lens “n” is incident to intersect with the signal light in a signal light incidence area in the record medium. By changing the incident angle of the reference light to the record medium by means of the rotation of the upper galvanomirror “m” and the upper 4f lens “n”, angle multiplex recording is performed from above.

The operation when recording by the lower hologram recording/reproducing optical system is as follows.

Light emitted from the lower light source “a1” passes through the lower expander “b1” and the lower first half-wave plate “c1” to be divided into signal light that passes through the lower first polarizing beam splitter “d1” and reference light that is reflected by it. Here, the ratio of the signal light to the reference light can be freely adjusted by the lower first half-wave plate “c1”.

The signal light is expanded in beam diameter by the upper second expander “e”1, passes through the lower second polarizing beam splitter “f1”, and is incident on the lower spatial light modulator “g1”. The components modulated to be in the ON state by this lower spatial light modulator “g1” of a reflective type are inverted in polarization and reflected by the lower second polarizing beam splitter “f1” to be incident on the lower Fourier lens “i1”. The components of the light put in the OFF state at the lower spatial light modulator remain unchanged in polarization and hence passes through the lower second polarizing beam splitter “f1” to go back toward the light source. The signal light condensed by the lower Fourier lens “i1” is incident on the record medium “o”.

Meanwhile, the reference light reflected by the lower first polarizing beam splitter “d1” passes through the lower second half-wave plate “j1”, remaining unchanged in polarization and is reflected by the lower mirrors “k1, l1” to be directed toward the lower galvanomirror “m1”. The reference light reflected by the lower galvanomirror “m1” and having passed through the lower 4f lens “n1” is incident to intersect with the signal light in a signal light incidence area in the record medium. By changing the incident angle of the reference light to the record medium by means of the rotation of the lower galvanomirror “m1” and the lower 4f lens “n1”, angle multiplex recording is performed from below.

The cases of performing normal reproduction and phase conjugate reproduction on a hologram area in the record medium “o” recorded by the upper optical system will be described.

<Normal Reproduction Operation of the Hologram Apparatus>

First, the case of normal reproduction will be described. In this case, reproduced light produced by the reference light of the upper optical system is detected by the lower optical system.

Light emitted from the upper light source “a”, passes through the upper expander “b” and the upper first half-wave plate “c” to be incident on the upper first polarizing beam splitter “d”. Light that passes through the upper first polarizing beam splitter is reduced to zero by the upper first half-wave plate “c” or cut off otherwise. The reflected reference light is inverted in polarization by the upper second half-wave plate “j”. The reference light inverted in polarization is reflected by the upper mirrors “k, l” to be directed toward the upper galvanomirror “m”. The reference light reflected by the upper galvanomirror and having passed through the upper 4f lens “n” is incident into a hologram area in the record medium “o”. By changing the incident angle of the reference light to the record medium by means of the rotation of the upper galvanomirror and the upper 4f lens, the reference light incident angles in multiplex recording are replicated, thereby normal-reproducing holograms.

Because the polarization of the reference light is inverted, reproduced light from the hologram area of the record medium that has passed through the lower Fourier lens “i1” and travelled to the lower second polarizing beam splitter “f1”, passes through the polarizing beam splitter and is detected by the lower photodetector “h1”.

<Phase Conjugate Reproduction Operation of the Hologram Apparatus>

Next, the case of phase conjugate reproduction will be described. In this case, phase conjugate reproduced light (second reproduced light) produced by the reference light of the lower optical system is detected by the upper optical system. The reproduced light and the second reproduced light travel in opposite directions from the record medium.

Light emitted from the lower light source “a1”, passes through the lower expander “b1” and the lower first half-wave plate “c1” to be incident on the lower first polarizing beam splitter “d1”. Light that passes through the lower first polarizing beam splitter is reduced to zero by the lower first half-wave plate “c1” or cut off otherwise. The reflected reference light is inverted in polarization by the lower second half-wave plate “j1”. The reference light inverted in polarization is reflected by the lower mirrors “k1, l1” to be directed toward the lower galvanomirror “m1”. The reference light reflected by the upper galvanomirror and having passed through the lower 4f lens “n1” is incident into a hologram area in the record medium “o”. By changing the incident angle of the reference light to the record medium by means of the rotation of the galvanomirror and the 4f lens, the inverted angles of the reference light incident angles in multiplex recording are realized, thereby phase-conjugate-reproducing holograms.

Because the polarization of the reference light is inverted, phase-conjugate reproduced light from the hologram area of the record medium that has passed through the upper Fourier lens “i” and travelled to the upper second polarizing beam splitter “f”, passes through the upper second polarizing beam splitter “f” and is detected by the upper photodetector “h”.

<Simultaneous Recording/Reproducing Operation of the Hologram Apparatus>

Although in the above the cases of multiplex recording into a record medium by the upper optical system and reproducing by the upper and lower optical systems have been described, simultaneously multiplex recording into a record medium and also simultaneously reproducing by the upper and lower optical systems are possible.

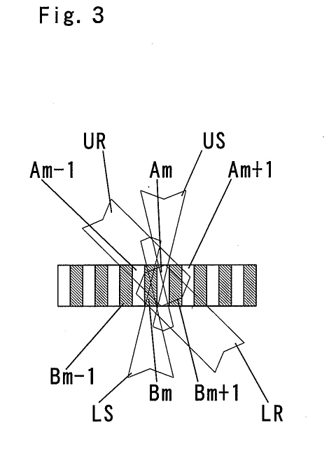

FIGS. 3 to 5 are schematic cross-sectional views showing in detail the part, related to incidence on the record medium “o”, of FIG. 2. Here, the signal light converging position of the upper optical system and the signal light converging position of the lower optical system coincide in an optical axis direction, but are displaced in a direction along which multiplex recorded holograms are arranged.

The operation in recording will be described using FIG. 3. The optical system above the record medium records holograms in an upper area Am (an area for the upper system) of the record medium by angle multiplexing of the signal light US and the reference light UR. At the same time, the lower optical system placed opposite thereto with the record medium in between, records holograms in a lower area Bm (an area for the lower system) next to the upper area Am of the record medium by angle multiplexing of the signal light LS and the reference light LR.

When angle multiplex recording into hologram areas that are being recorded into finishes, the upper optical system is aligned with the next upper area Am+1, and the lower optical system is aligned with the next lower area Bm+1 to perform angle multiplex recording. The upper areas Am and the lower areas Bm are alternately placed in the record medium. Further, the signal light of the upper optical system and the signal light of the lower optical system have their optical axes displaced in parallel basically by the minimum width (minimum diameter) of the upper areas Am or the lower areas Bm recorded in the record medium.

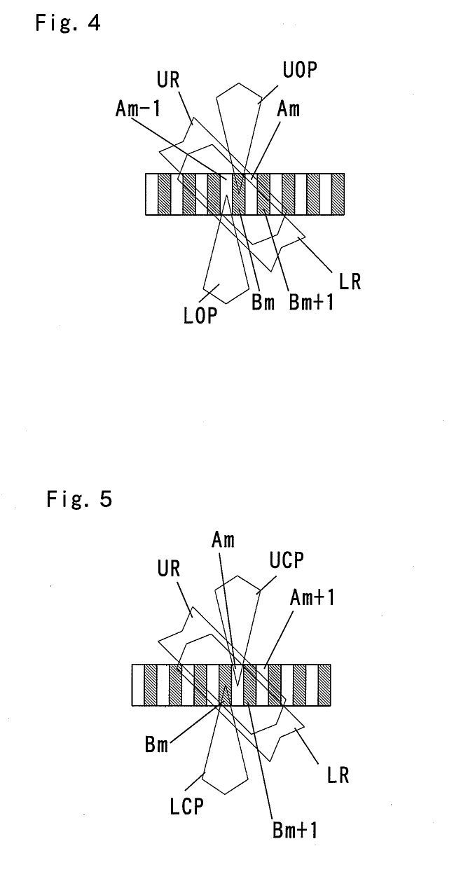

The operation in normal reproduction will be described using FIG. 4. The optical system above the record medium is aligned with the lower area Bm of the record medium, and reproduced light UOP of a hologram recorded in the lower area Bm is reproduced in the signal light incident direction of the upper optical system by the reference light LR of the lower optical system. At the same time, the lower optical system placed opposite thereto with the record medium in between is aligned with an upper area Am−1 of the record medium, and reproduced light LOP of a hologram recorded in the upper area Am−1 is reproduced in the signal light incident direction of the lower optical system by the reference light UR of the upper optical system. The reproduced light from the upper area and the reproduced light from the lower area travel in opposite directions from the record medium.

When reproduction of the angle multiplexed holograms in these areas finishes, the upper optical system is aligned with the next lower area Bm+1, and the lower optical system is aligned with the next upper area Am to continue reproduction.

The operation in phase conjugate reproduction will be described using FIG. 5. The optical system above the record medium is aligned with the upper area Am of the record medium, and phase-conjugate reproduced light UCP of a hologram recorded in the upper area Am is reproduced in the signal light incident direction of the upper optical system by the reference light LR of the lower optical system. At the same time, the lower optical system placed opposite thereto with the record medium in between is aligned with the lower area Bm, and phase-conjugate reproduced light LCP of a hologram recorded in the lower area Bm is reproduced in the signal light incident direction of the lower optical system by the reference light UR of the upper optical system. The reproduced light from the upper area and the reproduced light from the lower area travel in opposite directions from the record medium.

When reproduction of the angle multiplexed holograms in these areas finishes, the upper optical system is aligned with the next upper area Am+1, and the lower optical system is aligned with the next lower area Bm+1 to continue reproduction. The beam diameter of the reference light may be reduced in recording as compared with that in reproducing.

<Embodiment of Spatial Filter Use>

In reproduction shown in FIG. 4 or 5, if the upper area Am and the lower area Bm are very close to each other, reproduced lights or phase-conjugate reproduced lights from a plurality of hologram areas are reproduced in the signal light direction by one reference light, which is prevented with a spatial filter.

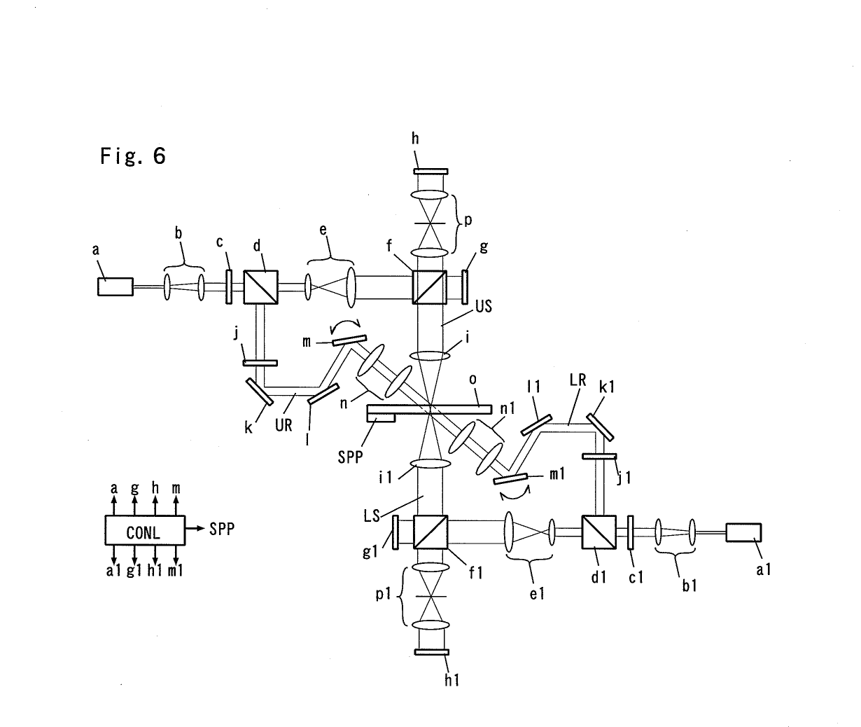

FIG. 6 shows example use of spatial filters. In order to detect only desired reproduced lights from among the plurality of reproduced lights or phase-conjugate reproduced lights, upper and lower spatial filters “p, p1” are respectively placed before the photodetectors “h, h1” of the upper and lower optical systems. The upper and lower spatial filters “p, p1” each comprise, for example, a pair of relay lenses and a minute-opening plate placed at their focal position. Because hologram areas to reproduce from are respectively located on the optical axes of the upper and lower Fourier lenses and their adjacent areas are away from the optical axis, desired reproduced lights pass through the minute openings and travel toward the upper and lower photodetectors “h, h1” respectively, while the other reproduced lights are cut off at the minute openings to be prevented from being incident on the photodetectors.

Further, although the light sources of the upper and lower optical systems are high in coherence, by making them not interfere with each other, no hologram will be recorded even if the signal light of the upper optical system and the reference light of the lower optical system intersect when recording.

<Variant of the Recording/Reproducing Method>

A variant is shown where the upper areas Am and the lower areas Bm are not alternately placed but arranged such that N (an integer) number of upper areas Am are followed by N number of lower areas Bm, which are followed by N number of upper areas Am, and so on. That is, upper-area A groups and lower-area B groups, each consisting of N consecutive recording areas, are indicated by (Am−1, Am, Am+1) , for the upper, and (Bm−1, Bm, Bm+1), for the lower, and recording areas contained in each of the upper-area groups Am−1, Am, Am+1 are indicated by (Am, 1), . . . , (Am, N), and recording areas contained in each of the lower-area groups Bm−1, Bm, Bm+1 are indicated by (Bm, 1), . . . , (Bm, N).

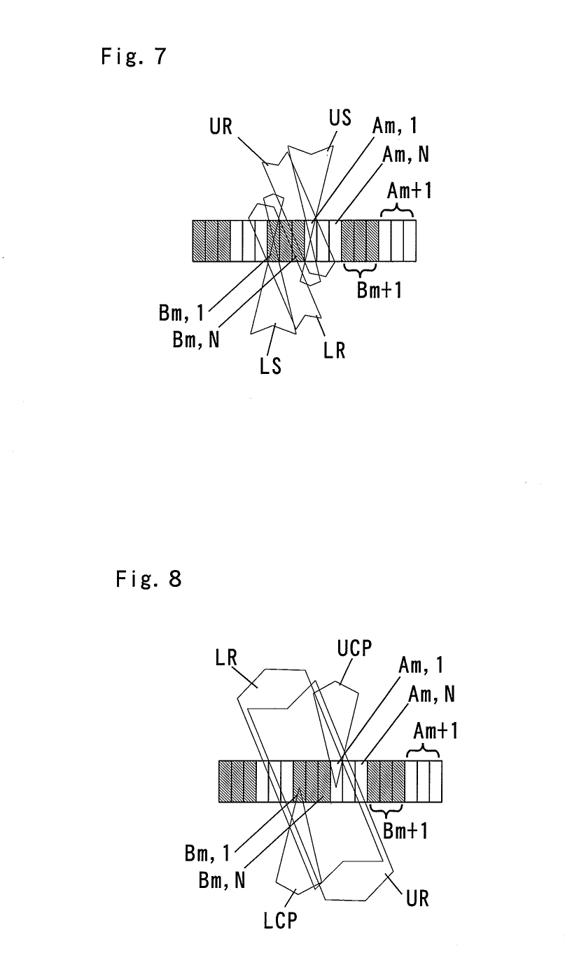

FIG. 7 shows the operation in recording. Angle multiplex recording is performed on the upper area (Am, 1) by the signal light US and the reference light UR of the upper optical system. At the same time, angle multiplex recording is performed on the lower area (Bm, 1) by the signal light LS and the reference light LR of the lower optical system. When the angle multiplex recording into areas that are being recorded into finishes, they are aligned with the next area to continue recording. When recording into N consecutive areas finishes, the upper optical system skips over N lower areas Bm+1 and is aligned with the next upper area (Am+1, 1) to continue recording. At the same time, the lower optical system skips over N upper areas Am and is aligned with the next lower area (Bm+1, 1) to continue recording. In the record medium, an upper-area A group of N areas is alternated with a lower-area B group of N areas. The signal light of the upper optical system and the signal light of the lower optical system have their optical axes spaced apart basically by the width of the upper-area A group of N areas or the lower-area B group of N areas recorded in the record medium.

FIG. 8 shows the operation in reproducing. The optical system above the record medium is aligned with the upper area (Am, 1) of the record medium, and phase-conjugate reproduced light UCP of a hologram recorded in the upper area (Am, 1) is reproduced in the signal light incident direction of the upper optical system by the reference light LR of the lower optical system. At the same time, the lower optical system placed opposite thereto with the record medium in between is aligned with the lower area (Bm, 1) of the record medium, and phase-conjugate reproduced light LCP of a hologram recorded in the lower area (Bm, 1) is reproduced in the signal light incident direction of the lower optical system by the reference light UR of the upper optical system. When reproduction of the angle multiplexed holograms in these areas finishes, the optical systems are moved to the next area to continue reproducing. When reproduction from N consecutive areas finishes, the upper optical system skips over N lower areas Bm+1 and is aligned with the next upper area (Am+1, 1) to continue reproducing. At the same time, the lower optical system skips over N upper areas Am and is aligned with the next lower area (Bm+1, 1) to continue reproducing. In the above, description has been made taking phase conjugate reproduction as an example, but normal reproduction can also be performed according to the description related to FIGS. 4 and 5.

FIGS. 7 and 8 are an example showing that the upper areas Am and the lower areas Bm need not be alternately placed individually and can be alternately placed in groups of N areas. Note that the arrangement of the areas does not mean physically partitioning the record medium but means a strategy about the way to use the areas of the record medium when recording. In this example, the optical axes of the signal light of the upper optical system and of the signal light of the lower optical system are spaced apart by the width of the upper-area A group of N areas or the lower-area B group of N areas recorded in the record medium. As a result, as shown in FIG. 7, the signal light of the upper optical system and the reference light of the lower optical system do not intersect in the record medium, and thus a hologram is not recorded. Likewise, the signal light of the lower optical system and the reference light of the upper optical system do not intersect in the record medium, and thus a hologram is not recorded. As such, there is the effect of preventing an unnecessary hologram from being recorded. Meanwhile, when reproducing, the beam diameter of the reference light needs to be expanded to cover holograms to be reproduced as shown in FIG. 8, or the optical axis of the reference light needs to be moved.

<Another Variant of the Recording/Reproducing Method>

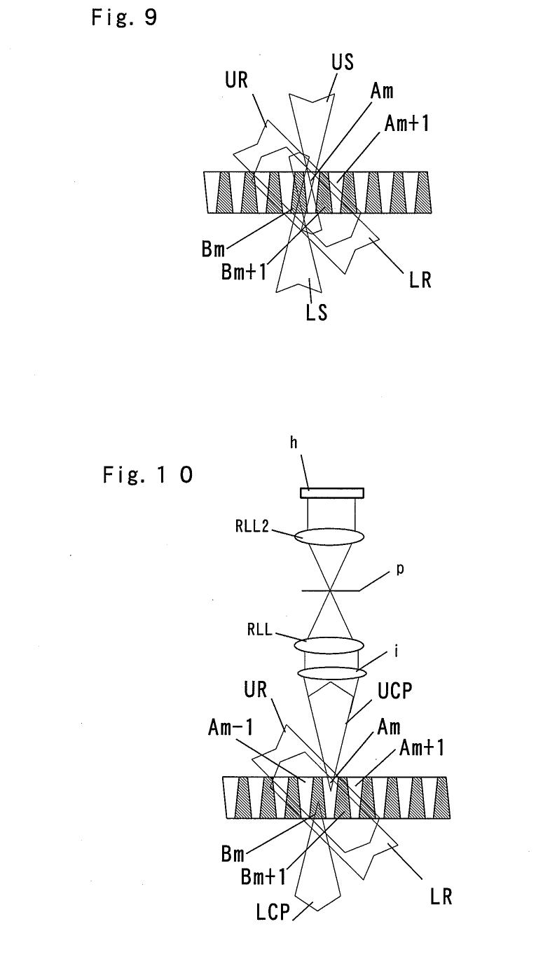

FIGS. 9 and 10 show another variant.

As shown in FIG. 9, the focal positions of the object lenses of the upper and lower optical systems are spaced apart in a direction of the optical axes, and in addition an area which is recorded by the upper optical system and an area which is recorded by the lower optical system are made to overlap completely, and thereby the recording capacity can be doubled. When recording, hologram recording areas Am angle-multiplex recorded into by the upper optical system are arranged with no space between them. An area Bm angle-multiplex recorded into by the lower optical system is positioned between the area Am−1 and the area Am so that the areas Am and the areas Bm overlap completely, thus doubling the recording capacity.

In this case, the areas Am and the areas Bm are in trapezoidal shapes that are upside down from each other. In this case, recording/reproducing operation is according to the description related to FIGS. 3 to 5.

FIG. 10 is an example of phase conjugate reproduction from the upper areas Am. The phase-conjugate reproduced light UCP read out by the reference light LR of the lower optical system passes through the upper Fourier lens “i” and the upper second polarizing beam splitter “f” (not shown) and is incident on a relay lens RLL. The light passes through the upper spatial filter “p” placed at the beam condensing position of the relay lens RLL and a second relay lens RLL2 and then is detected by the detector h. The upper spatial filter “p” has a pinhole diameter to allow the fundamental frequency component of a modulated signal to pass through. At this time, reproduced signals are read out also from the adjacent upper recording areas Anal and the adjacent lower recording area Bm by the same reference light of the lower optical system. Of these unnecessary reproduced signals, phase-conjugate reproduced signals from the adjacent upper areas Am±1 are cut off at the pinhole of the spatial filter to be not incident on the detector. The normal reproduced signal from the adjacent lower recording area Bm is light that has a spread at the upper spatial filter “p” because its condensing position by the relay lens is before the upper spatial filter “p”, and hence part of the light passing through the upper spatial filter “p” is minute in amount. Thus, the adjacent upper areas Am±1 can be made closer to the upper area Am, which is being reproduced from via the upper spatial filter “p”, as long as the signals from the adjacent upper areas are blocked by the upper spatial filter “p”. In practice, as to the upper area Am−1 in the record medium, the next upper area Am can be made to overlap it. Further, holograms for the lower area Bm are recorded in between the upper area Am−1 and the next upper area Am with the converging position of the signal light changed in a focusing direction. Thus, the recording capacity can be doubled.

<Yet Another Variant of the Recording/Reproducing Method>

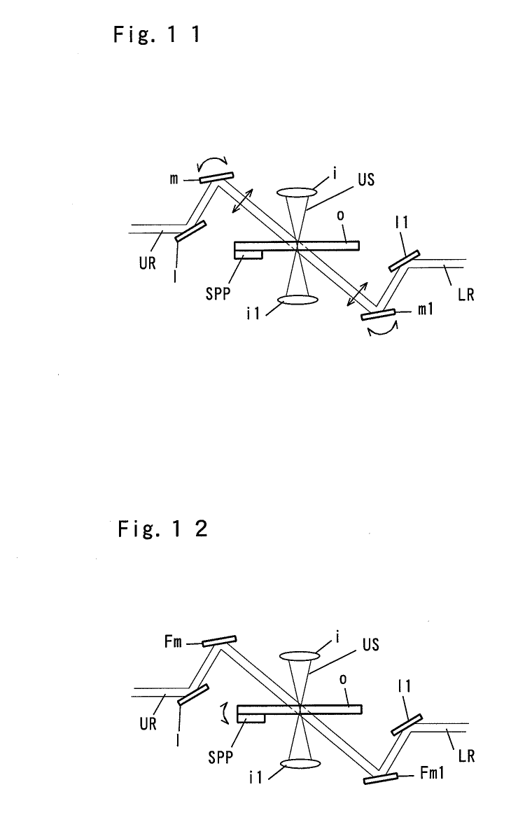

FIG. 11 is a schematic configuration diagram showing in detail the part related to incidence on a record medium in the hologram apparatus of another embodiment. The apparatus may be configured such that instead of changing the incident angles of the reference lights to the record medium “o” respectively by means of the rotation of the upper and lower galvanomirrors “m, m1” and the upper and lower 4f lenses “n, n1”, by moving the upper and lower galvanomirrors “m, m1” while rotating them, the incident angles of the reference lights to the record medium are changed, thereby performing angle multiplexing.

Further, as shown in FIG. 12, the apparatus may be configured such that instead of the upper and lower galvanomirrors “m, m1”, usual upper and lower fixed mirrors “Fm, Fm1” are used and that the record medium “o” is rotated by the support SPP or the like, thereby performing angle multiplexing. The configuration thereof is not limited to these because there are a variety of configurations of the optical system for performing angle multiplexing.

<Example of Diaphragm Use>

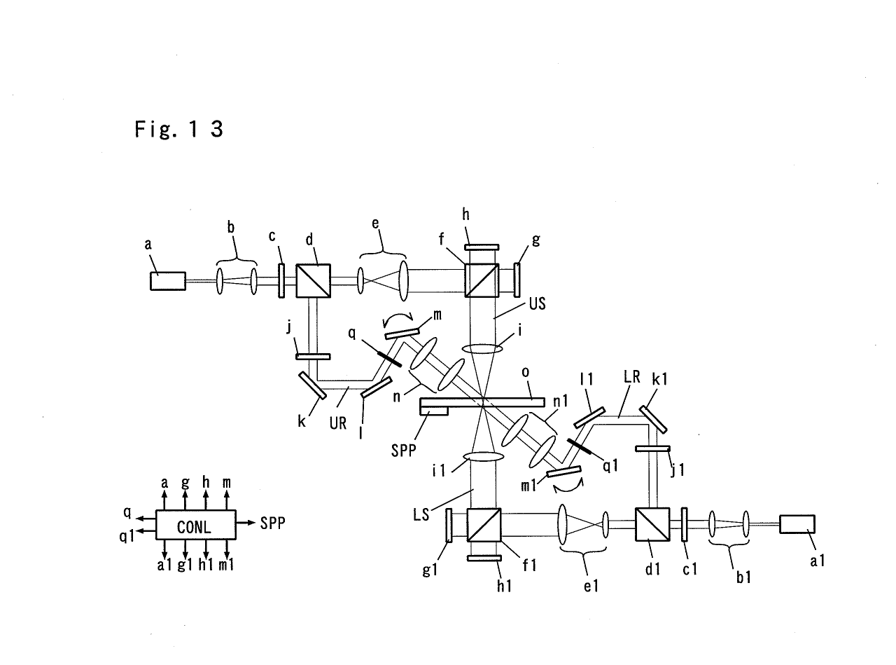

FIG. 13 shows an example of diaphragm use. FIG. 13 shows an example where a diaphragm to change the beam diameter of the reference light (the transverse section area of the reference light) is provided. Upper and lower diaphragms “q, q1” are placed between the upper and lower mirrors “l, l1” and the upper and lower galvanomirrors “m, m1” respectively. The upper and lower diaphragms “q, q1” are each constituted by a mechanical movable diaphragm shutter or the like.

When recording, the beam diameters of the reference lights are reduced by the upper and lower diaphragms “q, q1” to a limit of an area in a medium to record holograms into (the state shown in FIGS. 3 and 7). When reproducing, the diaphragms are opened to expand the beam diameters of the reference lights so as to irradiate the reference lights onto hologram areas to reproduce from (FIGS. 4, 5, and 8). When recording, in order not to reduce the sensitivity of the medium, the apparatus avoids unnecessary exposure as much as possible. When reproducing, there is no problem with unnecessary exposure because the sensitivity of the medium has been used up.

<Control Circuit>

In any of the above embodiments, the hologram apparatus has a control circuit CONL, which is connected to each of the upper light source “a”, the upper spatial light modulator “g”, the upper photodetector “h”, the upper galvanomirror “m”, the lower light source “a1”, the lower spatial light modulator “g1”, the lower photodetector “h1”, the lower galvanomirror “m1”, and the support SPP. The control circuit CONL performs control of these via drive circuits, and so on. The control circuit CONL is constituted by a microcomputer equipped with various memories and performs control such as synchronous control of the entire apparatus, and generates various control signals according to operation input from a user via an operation unit (not shown) and the current operation status of the apparatus and is connected to a display unit (not shown) to display the operation status and the like to the user. Liquid crystal shutters or the like (not shown) connected to the control circuit CONL may be respectively provided between the upper and lower first polarizing beam splitters d, d1 and the upper and lower second expanders e, e1 of the upper and lower optical systems to switch between recording and reproducing.

1. A hologram apparatus which comprises a support removably holding a record medium that stores therein optical interference patterns between coherent signal light and reference light as diffraction gratings; a light generating unit that generates coherent reference light and coherent signal light modulated according to information to be recorded; an interference optical system that irradiates said signal light and said reference light toward said record medium to intersect therein, thus forming a diffraction grating inside said record medium by an optical interference pattern; and a photodetector that detects reproduced light, said hologram apparatus further comprising:
a second interference optical system that irradiates second signal light and second reference light to intersect inside said record medium, wherein said second signal light and said second reference light are placed in the plane of incidence including said signal light and said reference light of said interference optical system so as to be opposite to said signal light and said reference light with said record medium sandwiched in between; and
a second photodetector that detects reproduced light.

2. A hologram apparatus according to claim 1, wherein said interference optical system and said second interference optical system have respective object lenses opposite to each other with said record medium in between, and a focal position of the object lens of said interference optical system and a focal position of the object lens of said second interference optical system are spaced a predetermined distance apart.

3. A hologram apparatus according to claim 2, wherein the focal position of the object lens of said interference optical system and the focal position of the object lens of said second interference optical system are spaced apart in a direction perpendicular to optical axes of the object lenses.

4. A hologram apparatus according to claim 3, wherein said predetermined distance is a minimum area diameter of holograms recorded in said record medium or a multiple of the minimum area diameter.

5. A hologram apparatus according to claim 2, wherein the focal position of the object lens of said interference optical system and the focal position of the object lens of said second interference optical system are spaced apart in a direction of optical axes of the object lenses and in a direction perpendicular to the optical axes.

6. A hologram apparatus according to claim 1, wherein spatial filters are respectively provided before light receiving portions of said photodetector and said second photodetector.

7. A hologram apparatus according to claim 1, wherein diaphragms to change transverse section areas of said reference light and said second reference light are respectively provided in said interference optical system and said second interference optical system.

8. A recording method in a hologram apparatus which comprises a support removably holding a record medium that stores therein optical interference patterns between coherent signal light and reference light as diffraction gratings; a light generating unit that generates coherent reference light and coherent signal light modulated according to information to be recorded; an interference optical system that irradiates said signal light and said reference light toward said record medium to intersect therein, thus forming a diffraction grating inside said record medium by an optical interference pattern; and a photodetector that detects reproduced light, said recording method comprising the steps of:
preparing a second interference optical system that irradiates second signal light and second reference light to intersect inside said record medium, wherein said second signal light and said second reference light are placed in the plane of incidence on said record medium including said signal light and said reference light of said interference optical system so as to be opposite to said signal light and said reference light with said record medium sandwiched in between, and a second photodetector that detects reproduced light; and
irradiating by said interference optical system and said second interference optical system simultaneously said signal light and said reference light, and said second signal light and said second reference light onto said record medium.

9. A recording method in a hologram apparatus according to claim 8, wherein said interference optical system and said second interference optical system have respective object lenses opposite to each other with said record medium in between, and a focal position of the object lens of said interference optical system and a focal position of the object lens of said second interference optical system are spaced apart in a direction perpendicular to optical axes of the object lenses.

10. A recording method in a hologram apparatus according to claim 9, wherein the focal position of the object lens of said interference optical system and the focal position of the object lens of said second interference optical system are spaced apart by a minimum area diameter of holograms recorded in said record medium or a multiple of the minimum area diameter.

11. A hologram apparatus according to claim 8, wherein said interference optical system and said second interference optical system have respective object lenses opposite to each other with said record medium in between, and a focal position of the object lens of said interference optical system and a focal position of the object lens of said second interference optical system are spaced apart in a direction of optical axes of the object lenses and in a direction perpendicular to the optical axes.

12. A recording method in a hologram apparatus according to claim 8, wherein spatial filters are respectively provided before light receiving portions of said photodetector and said second photodetector.

13. A recording method in a hologram apparatus according to claim 8, wherein diaphragms to change transverse section areas of said reference light and said second reference light are respectively provided in said interference optical system and said second interference optical system.

14. A reproducing method in a hologram apparatus which comprises a support removably holding a record medium that stores therein optical interference patterns between coherent signal light and reference light as diffraction gratings; a light generating unit that generates coherent reference light; an optical system that irradiates said reference light toward said record medium; and a photodetector that detects reproduced light, said reproducing method comprising the steps of:
preparing a second optical system that irradiates second reference light, which is placed opposite to said reference light with said record medium sandwiched in between, toward said record medium and a second photodetector that detects second reproduced light; and
irradiating by said optical system and said second optical system simultaneously said reference light and said second reference light onto said record medium,
wherein said reproduced light and said second reproduced light from said record medium are detected by said photodetector and said second photodetector, and said reproduced light and said second reproduced light travel in opposite directions from said record medium.

15. A reproducing method in a hologram apparatus according to claim 14, wherein said reference light is irradiated onto said record medium in substantially the same way as when said diffraction gratings were recorded.

16. A reproducing method in a hologram apparatus according to claim 14, wherein said second reference light is irradiated onto said record medium from a direction opposite to the incident direction of said reference light when said diffraction gratings were recorded.

17. A reproducing method in a hologram apparatus according to claim 14, wherein said optical system and said second optical system have respective object lenses opposite to each other with said record medium in between, and a focal position of the object lens of said optical system and a focal position of the object lens of said second optical system are spaced a predetermined distance apart.

18. A reproducing method in a hologram apparatus according to claim 17, wherein the focal position of the object lens of said optical system and the focal position of the object lens of said second optical system are spaced apart in a direction perpendicular to optical axes of the object lenses.

19. A reproducing method in a hologram apparatus according to claim 18, wherein said predetermined distance is a minimum area diameter of holograms recorded in said record medium or a multiple of the minimum area diameter.

20. A reproducing method in a hologram apparatus according to claim 17, wherein the focal position of the object lens of said optical system and the focal position of the object lens of said second optical system are spaced apart in a direction of optical axes of the object lenses and in a direction perpendicular to the optical axes.

21. A reproducing method in a hologram apparatus according to claim 14, wherein spatial filters are respectively provided before light receiving portions of said photodetector and said second photodetector.

22. A reproducing method in a hologram apparatus according to claim 14, wherein diaphragms to change transverse section areas of said reference light and said second reference light are respectively provided in said optical system and said second optical system.
